(19) United States
(12) Patent Application Publication
(10) Pub. No.: US 2017/0214045 A1
(43) Pub. Date: Jul. 27, 2017

(54) HIGH-ENERGY CATHODE ACTIVE MATERIALS FOR LITHIUM-ION BATTERIES

(71) Applicant: Apple Inc., Cupertino, CA (US)

(72) Inventors: Hongli Dai, Los Altos, CA (US); Huiming Wu, San Jose, CA (US)

(21) Appl. No.: 15/411,344

(22) Filed: Jan. 20, 2017

Related U.S. Application Data
(60) Provisional application No. 62/286,119, filed on Jan. 22, 2016.

(51) Int. Cl. H01M 4/525; H01M 10/0525; H01M 4/505

(52) U.S. Cl. CPC H01M 4/525; H01M 4/505; H01M 10/0525; H01M 2220/30; H01M 2004/028

(57) ABSTRACT

Compounds that can be used as cathode active materials for lithium ion batteries are described. In some embodiments, the cathode active material includes the compound LiₓNiₐM_{b}N_{c}O₂ where M is selected from Mn, Ti, Zr, Ge, Sn, Te and a combination thereof; N is selected from Mg, Be, Ca, Sr, Ba, Fe, Ni, Cu, Zn, and a combination thereof; 0.9<x<1.1; 0.7<a<1; 0<b<0.3; 0<c<0.3; and a+b+c=1. Other cathode active materials, precursors, and methods of manufacture are presented.

### CROSS-REFERENCE TO RELATED PATENT APPLICATION

This patent application claims the benefit of U.S. Patent Application No. 62/286,119, entitled “High-Energy Cathode Active Material for Lithium-Ion Battery,” filed on Jan. 22, 2016 under 35 U.S.C. §119(e), which is incorporated herein by reference in its entirety.

### FIELD

This disclosure relates generally to batteries, and more particularly, to cathode active materials for lithium-ion batteries.

### BACKGROUND

Lithium nickel oxide (LiNiO₂) has been studied for use in lithium ion batteries. Including Ni in the lithium layer can greatly decreases electrochemical performance. Conventional Ni layer materials focus on including Mn and Co elements. Examples of such materials include lithium nickel manganese cobalt oxide (NMC) and lithium nickel cobalt aluminum oxides (NCA). Current NMC materials enable capacities of 185 mAh/g when incorporated into battery cells.

There is a need for lithium nickel oxide cathode active materials that improve crystalline structure and electrochemical performance in battery cells. More specifically, there is a need for cathode compositions with higher structural stability, higher capacity, higher volumetric energy density, improved electrochemical stability, improved safety, and/or lower cost. These and other needs are addressed in the disclosure.

### SUMMARY

The embodiments presented herein describe cathode active materials for lithium ion batteries. In some embodiments, the disclosure provides a compound of Formula (I):

LiₓNiₐM_{b}N_{c}O₂

wherein M is at least one element selected from Mn, Ti, Zr, Ge, Sn, and Te; N is at least one element selected from Mg, Be, Ca, Sr, Ba, Fe, Ni, Cu, Zn, and any combination thereof; 0.9<x<1.1; 0.7<a<1; 0<b<0.3; 0<c<0.3; and a+b+c=1.

In other aspects, the disclosure provides a compound of Formula (III):

(1−y)LiₓNiₐM_{b}N_{c}O₂.yLi₂MeO₃

wherein M is at least one element selected from Mn, Ti, Zr, Ge, Sn, and Te; N is at least one element selected from Mg, Be, Ca, Sr, Ba, Fe, Ni, Cu, and Zn; Me is at least one element selected from Mn, Ti, Ru, and Zr; 0≦y≦0.3; 0.9<x<1.1; 0.7<a<1; 0<b<0.3; 0<c<0.3; and a+b+c=1. The compounds can be used as cathode active materials.

The disclosure is further directed to a powder including a coating disposed on a surface thereof and formed of a metal oxide, a metal fluoride, a metal phosphate, or any combination thereof. More than one coating may be used. In some embodiments, the coatings are formed of a material selected from the group consisting of Al₂O₃, ZnO, ZrO₂, MnO₂, CeO₂, Li₂MnO₃, TiO₂, MgO, AlOF, Zn₂OF₂, AlF₃, TiF₄, AlPO₄, FePO₄, NiPO₄, LiAlO₂, LiNiPO₄, CoPO₄, and LiCoPO₄.

### BRIEF DESCRIPTION OF THE DRAWINGS

The disclosure will be readily understood by the following detailed description in conjunction with the accompanying drawings, wherein like reference numerals designate like structural elements, and in which:

FIG. 1 is a schematic diagram of a top-down view of a battery cell in accordance with an illustrative embodiment;

FIG. 2 is a schematic diagram of a set of layers for a battery cell in accordance with an illustrative embodiment;

FIG. 3 is a ternary composition diagram for LiₓNiₐM_{b}N_{c}O₂, in accordance with an illustrative embodiment;

FIG. 4 is a ternary composition diagram for LiₓNiₐMn_{b}Mg_{c}O₂ where in 0.9<x<1.1, 0.7<a<1, 0<b<0.3, 0<c<0.3, and a+b+c=1, in accordance with an illustrative embodiment;

FIG. 5 is a ternary composition diagram representing possible chemistries for (1−y)LiₓNiₐM_{b}N_{c}O₂.yLi₂MeO₃ in accordance with an illustrative embodiment;

FIG. 6 is a schematic diagram of an electrochemical charge and discharge process for the cathode active material, (1−y)LiₓNiₐM_{b}N_{c}O₂.yLi₂MeO₃ in accordance with an illustrative embodiment;

FIG. 7 is a particle size distribution of a powder of Li_{1.02}Ni_{0.88}Mn_{0.10}Mg_{0.02}O₂ cathode active material, according to an illustrative embodiment;

FIG. 8A is a scanning electron micrograph of a powder of lithiated metal oxide Li_{1.02}Ni_{0.88}Mn_{0.10}Mg_{0.02}O₂ cathode active material at 200 times magnification, according to an illustrative embodiment;

FIG. 8B is a scanning electron micrograph of the powder of FIG. 8A, but at 1000 times magnification;

FIG. 8C is a scanning electron micrograph of the powder of FIG. 8A, but at 3000 times magnification;

FIG. 8D is a scanning electron micrograph of the powder of FIG. 8A, but at 5000 times magnification;

FIG. 9 is a graph containing a charge profile and a discharge profile of a coin cell incorporating a Li_{1.02}Ni_{0.88}Mn_{0.10}Mg_{0.02}O₂ cathode active material, according to an illustrative embodiment;

FIG. 10 is a plot of data representing a discharge capacity of a coin cell incorporating a Li_{1.02}Ni_{0.88}Mn_{0.10}Mg_{0.02}O₂ cathode active material during power cycling, according to an illustrative embodiment;

FIG. 11 is a plot of data representing a cycle retention of the coin cell of FIG. 10 during power cycling, according to some illustrative embodiments;

FIG. 12 is a variation of voltage with capacity of the coin cell of FIG. 10 during power cycling, according to some illustrative embodiments; and

FIG. 13 is a plot of data representing an energy density of the coin cell of FIG. 10 during power cycling, according to some illustrative embodiments.

### DETAILED DESCRIPTION

Reference will now be made in detail to representative embodiments illustrated in the accompanying drawings. It should be understood that the following descriptions are not intended to limit the embodiments to one preferred embodiment. To the contrary, it is intended to cover alternatives, modifications, and equivalents as can be included within the spirit and scope of the described embodiments as defined by the appended claims.

The disclosure is directed to Li ion cathode active materials that include Ni and can be used in battery cells. In various aspects, Li ion cathode active materials do not include Co. The cathode active materials can include one or more tetravalent metals, and one or more divalent metals. The cathode active materials can also include a stabilizer component to form an integrated or composite variant of the cathode active material. In additional variations, a coating layer can be applied on the surface of the cathode active material.

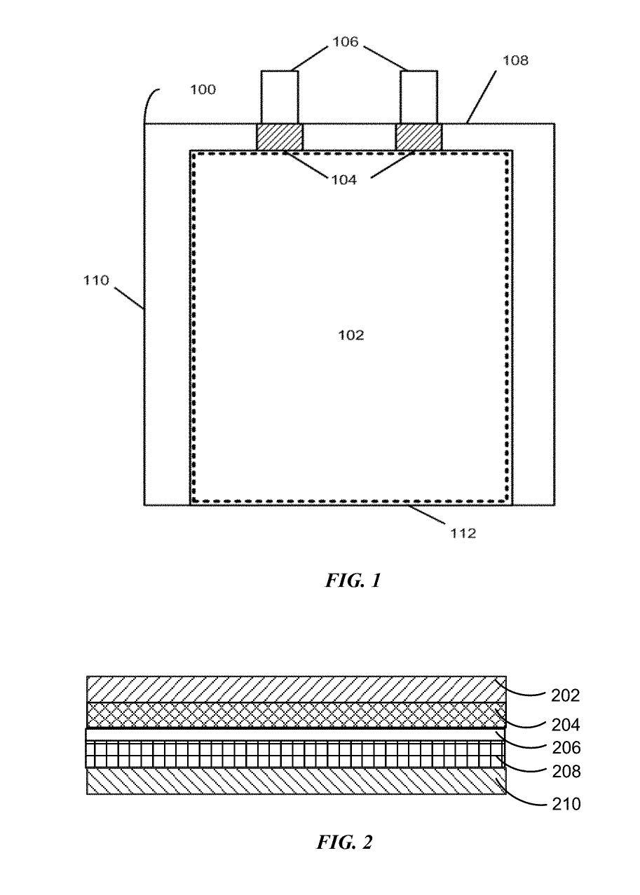

FIG. 1 shows a top-down view of a battery cell 100 in accordance with one variation of the disclosure. Battery cell 100 may correspond to a lithium-ion or lithium-polymer battery cell that is used to power a device used in a consumer, medical, aerospace, defense, and/or transportation application. Battery cell 100 includes a stack 102 containing a number of layers which that include a cathode with an active coating, a separator, and an anode with an active coating. More specifically, stack 102 may include one strip of cathode active material (e.g., aluminum foil coated with a lithium compound) and one strip of anode material (e.g., copper foil coated with carbon) separated by one strip of separator material (e.g., conducting polymer electrolyte). The cathode, anode, and separator layers may then be wound to form a spirally wound structure.

Battery cells can be enclosed in a flexible pouch. Returning to FIG. 1, during assembly of battery cell 100, stack 102 is enclosed in a flexible pouch, which is formed by folding a flexible sheet along a fold line 112. For example, the flexible sheet may be made of aluminum with a polymer film, such as polypropylene. After the flexible sheet is folded, the flexible sheet can be sealed, for example by applying heat along a side seal 110 and along a terrace seal 108.

Battery cell 100 also includes a set of conductive tabs 106 coupled to the cathode and the anode. In some embodiments, conductive tabs 106 may extend through seals in the pouch (for example, formed using sealing tape 104) to provide terminals for battery cell 100. Conductive tabs 106 may then be used to electrically couple battery cell 100 with one or more other battery cells to form a battery pack. For example, the battery pack may be formed by coupling the battery cells in a series, parallel, or series-and-parallel configuration. The coupled cells may be enclosed in a hard case to complete the battery pack, or the coupled cells may be embedded within the enclosure of a portable electronic device, such as a laptop computer, tablet computer, mobile phone, personal digital assistant (PDA), digital camera, and/or portable media player.

FIG. 2 shows a set of layers for a battery cell (e.g., battery cell 100 of FIG. 1) in accordance with the disclosed embodiments. The layers may include a cathode current collector 202, cathode active coating 204, separator 206, anode active coating 208, and anode current collector 210. Cathode current collector 202 and cathode active coating 204 may form a cathode for the battery cell, and anode current collector 210 and anode active coating 208 may form an anode for the battery cell. The layers may be wound or stacked to create the battery cell.

As mentioned above, cathode current collector 202 may be aluminum foil, cathode active coating 204 includes a lithium compound as described herein, anode current collector 210 may be copper foil, anode active coating 208 may include any suitable compound (e.g., carbon), and separator 206 may include a conducting polymer electrolyte.

It will be understood that the cathode active materials described herein can be used in conjunction with any battery cells, known in the art. For example, the stack in the battery cell can be a jelly roll, or the layers can be stacked, and/or used to form other types of battery cell structures, such as bi-cell structures. It will also be understood that the materials in the battery cells can include any suitable compounds known in the art.

### Compositions and Properties

In various examples of existing materials, Mn is Mn⁴⁺ and Co is Co³⁺. To maintain a transition-metal valency that averages, in total, 3+, a valence of Ni has to be less than 3+, which means Ni is partially divalent. Ni²⁺ can occupy the Li⁺ site and decrease electrochemical performance in battery cells.

In some variations, the disclosure is directed to a cathode active material for lithium ion batteries that includes a lithium nickel oxide (LiNiO₂) having one or more tetravalent metals selected from Mn, Ti, Zr, Ge, Sn, and Te and/or one or more divalent metals selected from Mg, Be, Ca, Sr, Ba, Fe, Ni, Cu, and Zn. In these materials, the trivalent Ni ion can serve as host to supply the capacity. Without wishing to be limited to any theory or mode of action, a tetravalent ion such as Mn⁴⁺, and a divalent ion such as Mg²⁺, can stabilize the structure and help Ni ion stay trivalent for typical layer LiNiO₂ oxide.

The lithium nickel oxide may also include a stabilizer component, Li₂MeO₃, in which Me is one or more elements selected from Mn, Ti, Ru, and Zr. Without wishing to be limited to any theory or mode of action, Li₂MeO₃ can stabilize a layered crystal structure and improve a reversible capability of LiₓNiₐM_{b}N_{c}O₂ in a voltage window of a lithium-ion cell.

In some variations, the cathode active material includes a compound represented by Formula (I):

LiₓNiₐM_{b}N_{c}O₂ (I)

where M is selected from Mn, Ti, Zr, Ge, Sn, Te, and a combination thereof; N is selected from Mg, Be, Ca, Sr, Ba, Fe, Ni, Cu, Zn, and a combination thereof; 0.9<x<1.1; 0.7<a<1; 0<b<0.3; 0<c<0.3; and a+b+c=1. In some variations of Formula (I), 0.05<b<0.3 and 0.05<c<0.3.

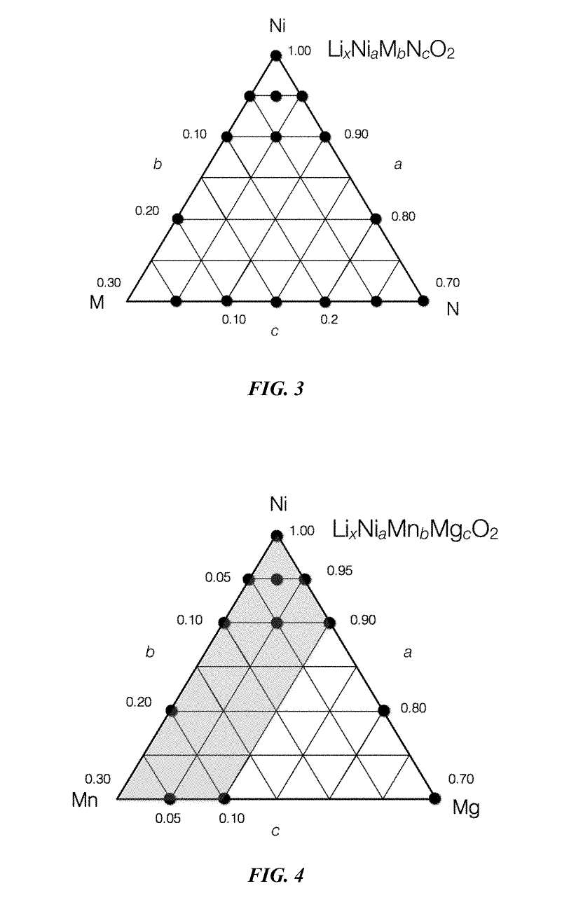

FIG. 3 presents a ternary composition diagram representing possible chemistries for LiₓNiₐM_{b}N_{c}O₂. The ternary composition diagram describes a Li—Ni-M-N oxide material where M is at least one element selected from the group consisting of Mn, Ti, Zr, Ge, Sn, and Te and N is at least one element selected from the group consisting of Mg, Be, Ca, Sr, Ba, Fe, Ni, Cu, and Zn.

In other variations, M is Mn and N is Mg. As such, the compound has the composition represented by Formula (II):

LiₓNiₐMn_{b}Mg_{c}O₂ (II)

where 0.9<x<1.1; 0.7<a<1; 0<b<0.3; 0<c<0.3; and a+b+c=1. In some variations of Formula (II), 0.05<b<0.3 and 0.05<c<0.3.

In compounds of Formula (II), a valence of Mg remains 2+ and a valence of Mn remains 4+. Again, without wishing to be held to a particular theory or mode of action, the valence of Mg remains 2+ to stabilize a layered crystal structure and improve electrochemical performance of the cathode active materials represented by Formula (II). As compared to known cathode formulae, the amount of Ni²⁺ can be reduced to achieve charge balance. Unlike Ni²⁺, which can transition electronically to Ni³⁺, Mg²⁺ represents a stable divalent ion in the cathode active material. Thus, in order to maintain an average transition-metal valency of 3+, a presence of Mg²⁺ in the cathode active material biases Ni away from Ni²⁺ to Ni³⁺. Such bias towards Ni³⁺ is decreases the availability of Ni²⁺ to occupy a Li⁺ site, which decreases performance of the cathode active material.

In some variations, Ni is an active transition metal at a higher stoichiometric amount than in conventional materials. In further variations, the active transition metal of Ni is trivalent in the material (i.e., 3+). During an electrochemical charge/discharge process in a cell, the redox couple between Ni³⁺/Ni⁴⁺ influences a capacity of the cell.

FIG. 4 presents a ternary phase diagram representing possible chemistries for LiₓNiₐMn_{b}Mg_{c}O₂. In this case, a shadowed portion of the ternary phase diagram corresponds to compositions having 0.9<x<1.1, 0.7<a<1, 0<b<0.3, 0<c<0.1, and a+b+c=1. In one example, a Ni-rich material of LiₓNiₐMn_{b}Mg_{c}O₂ is LiNi_{0.95}Mn_{0.025}Mg_{0.025}O₂.

The compounds of Formulae (I) and (II) as disclosed herein have properties that are surprisingly improved over properties of known compositions.

In some variations, a stabilizer component is added to an active component in the cathode active material. As such, the cathode active material includes a compound represented by Formula (III):

(1−y)LiₓNiₐM_{b}N_{c}O₂.yLi₂MeO₃ (III)

In Formula (III), LiₓNiₐM_{b}N_{c}O₂ serves as the active component and Li₂MeO₃ serves as the stabilizer component. The compound of Formula (III) corresponds to integrated or composite oxide material. A ratio of the components is governed by y, which ranges according to 0≦y≦0.3. For the LiₓNiₐM_{b}N_{c}O₂ active component, M is selected from Mn, Ti, Zr, Ge, Sn, Te, and any combination thereof; N is selected from Mg, Be, Ca, Sr, Ba, Fe, Ni, Cu, Zn, and any combination thereof; 0.9<x<1.1; 0.7<a<1; 0<b<0.3; 0<c<0.3; and a+b+c=1. For the Li₂MeO₃ stabilizer component, Me is selected from Mn, Ti, Ru, Zr, and any combination thereof. In some variations of Formula (III), 0.05<b<0.3 and 0.05<c<0.3.

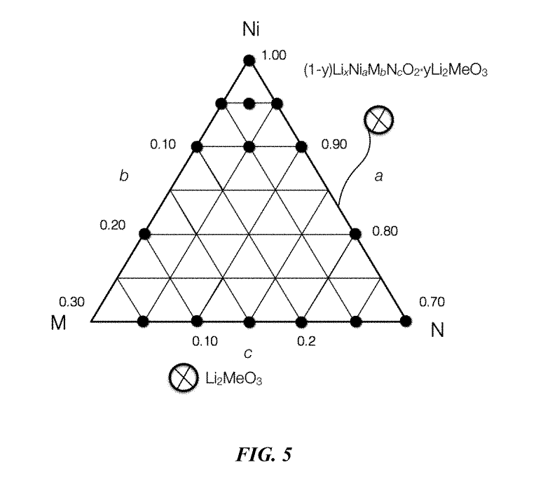

FIG. 5 presents a ternary composition diagram representing possible chemistries for (1−y)LiₓNiₐM_{b}N_{c}O₂.yLi₂MeO₃. The ternary composition diagram describes an Li—Ni-M-N oxide material having an Li-Me oxide component with a 2:1 Li:Me ratio. For the ternary composition diagram, M is at least one element selected from the group consisting of Mn, Ti, Zr, Ge, Sn, and Te; N is at least one element selected from the group consisting of Mg, Be, Ca, Sr, Ba, Fe, Ni, Cu, and Zn; and Me is at least one element selected from the group consisting of Mn, Ti, Ru, and Zr.

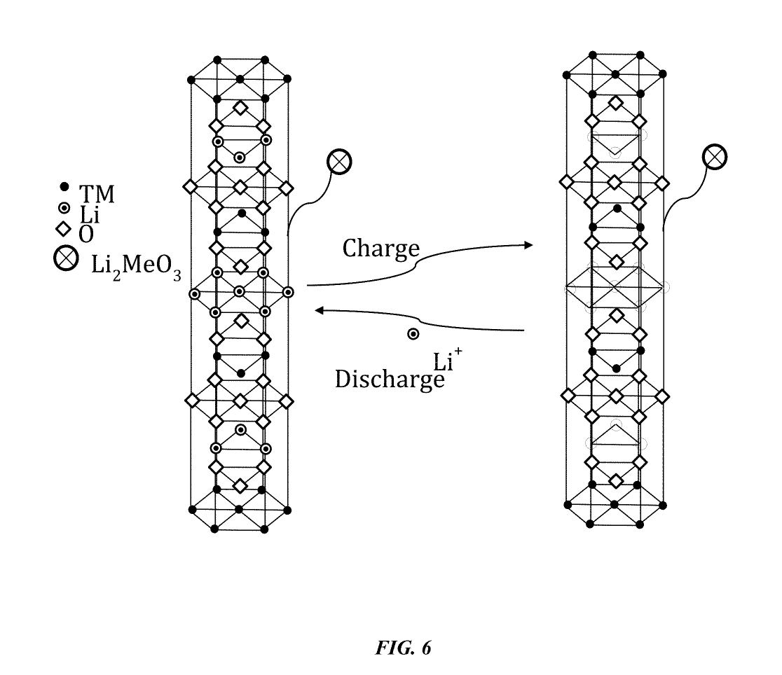

FIG. 6 presents an electrochemical charge and discharge process for the cathode active material of Formula (III). Without wishing to be limited to any theory or mode of action, the stabilizer component, Li₂MeO₃, integrates with the active component, LiₓNiₐM_{b}N_{c}O₂, which has a layered crystal structure. During charging of a battery cell, the cathode active material loses lithium ions, Li⁺, from the active component, LiₓNiₐM_{b}N_{c}O₂. The stabilizer component, Li₂MeO₃, is stable and does not participate in this de-lithiation process. During discharging, lithium ions are inserted into the active component, but the stabilizer component does not participate in this re-lithiation process (i.e., is stable). In general, the stabilizer component is chemically inactive. However, for the cathode active material to exhibit higher capacities, an amount of Li₂MnO₃ integrated into the cathode active material can be kept low.

In other variations, M is Mn, N is Mg, and Me is Mn. As such, the cathode active material has the composition represented by Formula (IV):

(1−y)LiₓNiₐMn_{b}Mg_{c}O₂.yLi₂MnO₃ (IV)

where 0≦y≦0.3; 0.9<x<1.1; 0.7<a<1; 0<b<0.3; 0<c<0.3; and a+b+c=1. In some variations of Formula (IV), 0.05<b<0.3 and 0.05<c<0.3.

In one example, a Ni-rich material of (1−y)LiₓNiₐMn_{b}Mg_{c}O₂.yLi₂MnO₃ is 0.98LiNi_{0.95}Mn_{0.025}Mg_{0.025}O₂.0.02Li₂MnO₃, which may also be written as Li_{1.01}Ni_{0.921}Mn_{0.0440}Mg_{0.0242}O₂. In this example, the ratio of Li to total metals content is greater than unity (i.e., Li/(Ni+M+N+Me)>1).

During electrochemical charging and discharging a lithium-ion battery, the cathode active material of Formula (IV) may alter in chemistry according to Equation (1):

(1−y)LiNiₐMn_{b}Mg_{c}O₂.yLi₂MnO₃ [symbol] zLi⁺+(1−y)Li_{x-z}NiₐMn_{b}Mg_{c}O₂.yLi₂MnO₃+ze⁻ (1)

where 0<z≦(1−y). In Equation (1), the active component, LiNiₐMn_{b}Mg_{c}O₂, supplies lithium ions while the stabilizer component, Li₂MnO₃, enables the cathode active material retain its crystal structure during de-lithiation. This advantage improves a work voltage window for the active component. A cut-off voltage window of the cathode active material can be extended by electrochemically extracting lithium ions from the stabilizer component. However, unlike with LiNiₐMn_{b}Mg_{c}O₂, such electrochemical extraction is not reversible for Li₂MnO₃.

In some variations, the compositions disclosed herein have a capacity over 200 mAh/g. In some variations, the compositions disclosed herein have a capacity over 210 mAh/g. In some variations, the compositions disclosed herein have a capacity over 220 mAh/g. In some variations, the compositions disclosed herein have a capacity over 230 mAh/g. In some variations, the compositions disclosed herein have a capacity over 240 mAh/g. In some variations, the compositions disclosed herein have a capacity is over 250 mAh/g.

In some variations, a battery containing the compound as a cathode active material can retain greater than 75% of its charge capacity over fifty cycles. In some variations, a battery containing the compound as a cathode active material can retain greater than 80% of its charge capacity over fifty cycles. In some variations, a battery containing the compound as a cathode active material can retain greater than 5% of its charge capacity over fifty cycles. In some variations, a battery containing the compound as a cathode active material can retain greater than 90% of its charge capacity over fifty cycles.

In some variations, an average voltage of a Li battery that includes the composition is greater than 3.55 V. In some variations, an average voltage of a Li battery that includes the composition is greater than 3.65 V. In some variations, an average voltage of a Li battery that includes the composition is greater than 3.75 V. In some variations, an average voltage of a Li battery that includes the composition is greater than 3.85 V. In some variations, an average voltage of a Li battery that includes the composition is greater than 4.00 V. In some variations, an average voltage of a Li battery that includes the composition is greater than 4.10 V. In some variations, an average voltage of a Li battery that includes the composition is greater than 4.20 V. In some variations, an average voltage of a Li battery that includes the composition is greater than 4.30 V. In some variations, an average voltage of a Li battery that includes the composition is greater than 4.40 V. In some variations, an average voltage of a Li battery that includes the composition is greater than 4.50 V. In some variations, an average voltage of a Li battery that includes the composition is greater than 4.60 V.

In some variations, batteries that include the composition as a cathode active material have a volumetric energy density greater than or equal to 2400 Wh/L. In some variations, the batteries that include the composition as a cathode active material have a volumetric energy density greater than or equal to 2500 Wh/L. In some variations, batteries that include the composition as a cathode active material have a volumetric energy density greater than or equal to 2600 Wh/L. In some variations, batteries that include the composition as a cathode active material have a volumetric energy density greater than or equal to 2700 Wh/L. In some variations, batteries that include the composition as a cathode active material have a volumetric energy density greater than or equal to 2800 Wh/L. In some variations, the batteries that include the composition as a cathode active material have a volumetric energy density greater than or equal to 2900 Wh/L. In some variations, batteries that include the composition as a cathode active material have a volumetric energy density greater than or equal to 3000 Wh/L. In some variations, batteries that include the composition as a cathode active material have a volumetric energy density greater than or equal to 3100 Wh/L. In some variations, batteries that include the composition as a cathode active material have a volumetric energy density greater than or equal to 3200 Wh/L. In some variations, the batteries that include the composition as a cathode active material have a volumetric energy density greater than or equal to 3300 Wh/L. In some variations, batteries that include the composition as a cathode active material have a volumetric energy density greater than or equal to 3350 Wh/L. In some variations, batteries that include the composition as a cathode active material have a volumetric energy density greater than or equal to 3500 Wh/L. In some variations, batteries that include the composition as a cathode active material have a volumetric energy density greater than or equal to 3600 Wh/L.

In some variations, batteries containing the compositions as a cathode active material retain at least 75% of its energy density over fifty cycles. In some variations, batteries containing the compositions as a cathode active material retain at least 80% of its energy density over fifty cycles. In some variations, batteries containing the compositions as a cathode active material retain at least 85% of its energy density over fifty cycles. In some variations, batteries containing the compositions as a cathode active material retain at least 90% of its energy density over fifty cycles.

In various embodiments, the compositions have improved structure stability, electrochemical stability, lower BET surface area, lower gassing propensity, higher safety and acceptable rate capacity, and high pellet density. Batteries including the compositions also have improved cycling performance relative to batteries based on known compositions.

In some further variations, the cathode active material includes a coating disposed on a surface thereof. The coating can improve a performance of lithium-ion batteries that included the coated cathode active material. In various embodiments, the coating, which may be a layer, can include a metal oxide, a metal fluoride, a metal phosphate, or any combination thereof. Non-limiting examples of such compositions include Al₂O₃, ZnO, ZrO₂, MnO₂, CeO₂, Li₂MnO₃, TiO₂, MgO, AlOF, Zn₂OF₂, AlF₃, TiF₄, AlPO₄, FePO₄, NiPO₄, LiAlO₂, LiNiPO₄, CoPO₄, and LiCoPO₄.

In some variations, the coating is represented by a weight percent (i.e., wt %) of the total cathode active material. For example, in some variations the coating material can be greater than 0.1 wt % of the total cathode composition. In some variations the coating material can be greater than 0.2 wt % of the total cathode composition. In some variations the coating material can be greater than 0.4 wt % of the total cathode composition. In some variations the coating material can be greater than 0.6 wt % of the total cathode composition. In some variations the coating material can be less than 0.8 wt % of the total cathode composition. In some variations the coating material can be less than 0.6 wt % of the total cathode composition. In some variations the coating material can be less than 0.4 wt % of the total cathode composition. In some variations the coating material can be less than 0.2 wt % of the total cathode composition.

In some variations, a thickness of the coating is less than 50 nm. In some variations, the coating thickness is less than 80 nm. In some variations, the thickness is less than 70 nm. In some variations, the thickness is less than 60 nm. In some variations, the thickness is less than 50 nm. In some variations, the thickness is less than 40 nm. In some variations, the thickness is less than 30 nm. In some variations, the thickness is less than 20 nm.

In some variations, more than one coating on the cathode active material can be used (e.g., two coatings, three coatings, four coatings, etc.). The coatings need not be the same composition. For example, and without limitation, a cathode active material including A compound of Formulae (I) or (II) (e.g., LiNi_{0.95}Mn_{0.025}Mg_{0.025}O₂) is first coated with Al₂O₃ and then subsequently coated with AlF₃. In another non-limiting example, a cathode active material of Formula (III) or (IV) (e.g., 0.98LiNi_{0.95}Mn_{0.025}Mg_{0.025}O₂.0.02Li₂MnO₃) is first coated with Al₂O₃ and then subsequently coated with AlF₃.

In some variations, cathode active materials with different coatings can be combined. For example, and without limitation, a first cathode active material of LiNi_{0.95}Mn_{0.025}Mg_{0.025}O₂, coated with Al₂O₃, can be combined with a second cathode active material of LiNi_{0.95}Mn_{0.025}Mg_{0.025}O₂, coated with AlF₃. In another non-limiting example, a first cathode active material of 0.98LiNi_{0.95}Mn_{0.025}Mg_{0.025}O₂.0.02Li₂MnO₃, coated with Al₂O₃, can be combined with a second cathode active material of 0.98LiNi_{0.95}Mn_{0.025}Mg_{0.025}O₂.0.02Li₂MnO₃, coated with AlF₃.

In general, cathode active materials of any composition and any coating can be combined (e.g., a first cathode active material of LiNi_{0.95}Mn_{0.025}Mg_{0.025}O₂, coated with Al₂O₃, can be combined with a second cathode active material of 0.98LiNi_{0.95}Mn_{0.025}Mg_{0.025}O₂.0.02Li₂MnO₃, coated with AlF₃).

In various embodiments, the compositions have improved structural stability. The compositions also can have improved electrochemical stability and safety. The cathode active material disclosed here may achieve a high capacity of 230 mAh/g at 4.3 V and 250 mAh at 4.5 V, which is significantly higher than existing NMC material (i.e., 185 mAh/g at 4.3 V and 210 mAh/g at 4.5 V). The compounds disclosed herein can have improved properties, including excellent cycling performance, lower BET surface area, lower gassing propensity, higher safety and acceptable rate capacity and high pellet density.

### Methods of Manufacture

The present disclosure further provides methods of making the cathode active materials. The methods can include steps of preparing the precursor to the cathode active material, calcination (lithiation), and coating the material.

A precursor is prepared by a co-precipitation process to form high-density spherical particles of a cathode precursor material. In some variations, the cathode precursor material has a composition that is represented by Formula (V):

NiₐM_{b}N_{c}Me_{d}(OH)₂ (V)

where M is selected from Mn, Ti, Zr, Ge, Sn, Te, and a combination thereof; N is selected from Mg, Be, Ca, Sr, Ba, Fe, Ni, Cu, Zn, and a combination thereof; Me is selected from Mn, Ti, Ru, Zr, and a combination thereof; 0.7<a<1; 0<b<0.3; 0<c<0.3; 0≦d≦0.3. In some variations of Formula (V), 0.05<b<0.3 and 0.05<c<0.3.

In some variations, the precursor composition of the cathode precursor material is represented by Formula (VI):

NiₐMn_{b}Mg_{c}Me_{d}(OH)₂ (VI)

where Me is selected from Mn, Ti, Ru, Zr, and any combination thereof; 0.7<a<1; 0<b<0.3; 0<c<0.3; 0≦d≦0.3. In some variations of Formula (VI), 0.9<x<1.1; 0.7<a<1, 0.05<b<0.3, 0.05<c<0.3. In some variations of Formula (VI), Me is Mn. In some variations of Formula (VI), 0.05<b<0.3, 0.05<c<0.3, and Me is Mn.

Co-precipitation methods can be used to make precursor particles of NiₐM_{b}N_{c}Me_{d}(OH)₂ or NiₐMn_{b}Mg_{c}Me_{d}(OH)₂. In general, salts of nickel, manganese, magnesium and Me are combined in solution at a specific ratio. A pH of the solution is altered to reach a predetermined pH. Particulate seeds nucleate and then grow to form precursor particles. The precursor particles are washed, filtered, and dried.

The precursor particles are contacted (e.g., blended) with a lithium source and then calcined (i.e., lithiated) to form the cathode active material. The calcination process can be performed in an oxygen environment to ensure Ni constituents exhibit a valency of 3+. In some embodiments, the precursor particles are blended with lithium hydroxide, heated under oxygen for an extended period, then cooled to form the cathode active material. It will be appreciated that the precursor particles of NiₐMn_{b}Mg_{c}Me_{d}(OH)₂ can be blended with different ratios of the lithium source to achieve compositions of the cathode active material that correspond to LiₓNiₐM_{b}N_{c}O₂ or its composite variant, (1−y)LiₓNiₐM_{b}N_{c}O₂.yLi₂MeO₃.

After formation of the cathode active material, particles of the cathode active material can be coated using wet- and dry-coating methods. In wet-coating methods, particles of the cathode active material are contacted with a liquid (e.g., suspended in solution and filtered). A thin surface layer results that uniformly coats a surface of the particles. In dry coating methods, particles of the cathode active material are mixed with a coating material (e.g., nano-particles) in a dry coater. The coating material adheres to the surface of the particles, which may involve uniform but discontinuous coverage. Dry coating can reduce destruction of the cathode active material particle surface.

### EXAMPLES

The following examples are for illustration purposes only. It will be apparent to those skilled in the art that many modifications, both to materials and methods, may be practiced without departing from the scope of the disclosure.

### Example 1

A precursor material of Ni_{0.95}Mn_{0.025}Mg_{0.025}(OH)₂ was prepared. A stirred tank reactor (3.5-liter) was filled with distilled water and heated to 55° C. Water therein was purged with nitrogen while stirring at a rate of 1600 rpm. A 2 M aqueous solution was prepared using nickel sulfate, manganese sulfate, and magnesium nitrate. The 2 M aqueous solution had an Ni:Mn:Mg ratio of 95:2.5:2.5. To this solution, a 5 M solution of aqueous ammonia was continuously dripped into the reactor. The pH was fixed at 11.5 by adding a 10.0 molar aqueous solution of sodium hydroxide using a pH controller/pump, Precursor particles nucleated and grew in the combined solution over run time of 24 hours. The precursor particles were washed, filtered and dried.

### Example 2

Precursor particles prepared according to Example 1 were calcined in order to form LiNi_{0.95}Mn_{0.025}Mg_{0.025}O₂. The precursor particles were mixed in an orbital mixer with lithium hydroxide. Following mixing, the mixed powder was transferred to an alumina high-temperature tray and heated in a furnace in flowing oxygen at 500° C. for 10 hours. A ramp rate of the furnace was 2° C. per minute. The heated powder was allowed to cool in the furnace after it is turned off. The sample was subsequently ground by mortar and pestle, sieved, and then re-fired at 700° C. in flowing oxygen gas for 5 hours. The ramp rate was 2° C. per minute. After the second heating was completed, the furnace was turned off and the heated powder allowed to cool (i.e., using a natural cooling rate). This final sintered powder, which was black in appearance, was broken up and ground by mortar and pestle, sieved, and then collected for use in an electrochemical battery cell.

### Example 3

A cathode active material prepared according to Example 2 was coated with Al₂O₃ using a wet-coating method. An aqueous solution of Al(NO₃)₃ was prepared and particles of LiNi_{0.95}Mn_{0.025}Mg_{0.025}O₂ were suspended therein. This suspension was pumped into a continuous stirred-tank reactor and mixed. An ammonia solution was added into the suspension as needed to control a reaction pH. The reaction pH was held at 9.3 using the feedback pump. The suspension was stirred in the reactor for 2 hours, filtered, and then dried. The dried powder was calcined at 400° C. for 5 hours under a flow of oxygen. The coated cathode active material corresponded to Al₂O₃-coated LiNi_{0.95}Mn_{0.025}Mg_{0.025}O₂.

### Example 4

A cathode active material prepared according to Example 2 was coated with AlF₃ using a dry-coating technique. An amount of base material, i.e., a powder of LiNi_{0.95}Mn_{0.025}Mg_{0.025}O₂ cathode active material, was weighed out and poured into a dry coater. A nano-crystalline powder of AlF₃ was added as needed for a desired amount of coating (e.g., 0.1 wt %). (The nano-crystalline powder was weighed out and poured into the dry coater). For a 0.1 wt % coating, 0.5 g of AlF₃ was mixed thoroughly with 500 g of base material in the dry coater. A speed of the dry coater was held at 4000 rpm. After 5 minutes of mixing, a coated cathode active material was formed. The coated cathode active material corresponded to AlF₃-coated LiNi_{0.95}Mn_{0.025}Mg_{0.025}O₂.

### Example 5

A precursor material of Ni_{0.921}Mn_{0.0440}Mg_{0.0242}(OH)₂ was prepared. A stirred tank reactor (3.5-liter) was filled with distilled water and heated to 55° C. Water therein was purged with nitrogen while stirring at a rate of 1600 rpm. A 2 M aqueous solution was prepared using nickel sulfate, manganese sulfate, and magnesium nitrate. The 2 M aqueous solution had an Ni:Mn:Mg ratio of 0.921:0.440:0.0242. To this solution, a 5 M solution of aqueous ammonia was continuously dripped into the reactor. The pH was fixed at 11.5 by adding a 10.0 molar aqueous solution of sodium hydroxide using a pH controller/pump. Precursor particles were allowed to nucleate and grow in the combined solution over run time of 24 hours. The precursor particles were washed, filtered and dried.

### Example 6

Precursor particles prepared according to Example 5 were calcined in order to form 0.98LiNi_{0.95}Mn_{0.025}Mg_{0.025}O₂.0.021Li₂MnO₃(Li_{1.01}Ni_{0.921}Mn_{0.0440}Mg_{0.0242}O₂), The precursor particles were mixed in an orbital mixer with lithium hydroxide. Following mixing, the mixed powder was transferred to an alumina high-temperature tray and heated in a furnace in flowing oxygen at 500° C. for 10 hours. A ramp rate of the furnace was 2° C. per minute. The heated powder was allowed to cool in the furnace after the furnace is turned off. The sample was subsequently ground by mortar and pestle, sieved, and then re-fired at 700° C. in flowing oxygen gas for 5 hours. The ramp rate was 2° C. per minute. After the second heating was completed, the furnace was turned off and the heated powder allowed to cool (i.e., using a natural cooling rate). This final sintered powder, which was black in appearance, was broken up and ground by mortar and pestle, sieved, and collected.

### Example 7

A cathode active material prepared according to Example 6 is coated with Al₂O₃ using a wet-coating method. An aqueous solution of Al(NO₃)₃ is prepared and particles of 0.98LiNi_{0.95}Mn_{0.025}Mg_{0.025}O₂.0.02Li₂MnO₃ are suspended therein. This suspension is pumped into a continuous stirred-tank reactor and mixed. An ammonia solution is added into the suspension as needed to control a reaction pH. The reaction pH is held at 9.3 using the feedback pump. The suspension is stirred in the reactor for 2 hours, filtered, and then dried. The dried powder is calcined at 400° C. for 5 hours under a flow of oxygen. The coated cathode active material corresponds to Al₂O₃-coated 0.98LiNi_{0.95}Mn_{0.025}Mg_{0.025}O₂.0.02Li₂MnO₃.

### Example 8

A cathode active material prepared according to Example 6 is coated with AlF₃ using a dry-coating technique. An amount of base material, i.e., a powder of 0.98LiNi_{0.95}Mn_{0.025}Mg_{0.025}O₂.0.02Li₂MnO₃ cathode active material, is weighed out and poured into a dry coater. A nano-crystalline powder of AlF₃ is added as needed for a desired amount of coating (e.g., 0.1 wt %). (The nano-crystalline powder is weighed out and poured into the dry coater). For a 0.1 wt % coating, 0.5 g of AlF₃ is mixed thoroughly with 500 g of base material in the dry coater. A speed of the dry coater is held at 4000 rpm. After 5 minutes of mixing, a coated cathode active material is formed. The coated cathode active material corresponds to AlF₃-coated 0.98LiNi_{0.95}Mn_{0.025}Mg_{0.025}O₂.0.02Li₂MnO₃.

### Example 9

A precursor material of Ni_{0.88}Mn_{0.10}Mg_{0.02}(OH)₂ was prepared. A stirred tank reactor (30-liter) with four baffles was filled with 20 liters of distilled water (i.e., to form an initial supernatant). The distilled water was purged with nitrogen and heated to 60° C. An impeller having upper and lower paddles was used to stir the distilled water at a rate of 400 rpm. A 2.3 M aqueous solution was prepared using nickel sulfate, manganese sulfate, and magnesium nitrate and added to the distilled water at a rate of 27.62 mL/min. The 2.3 M aqueous solution had an Ni:Mn:Mg ratio of 0.88:0.10:0.02. To this on-going combination, an aqueous solution of sodium hydroxide (10% by weight) was continuously added at a rate of 6.5 mL/min. Similarly, an aqueous solution of ammonia (10% by weight) was continuously added at a rate of 15.58 mL/min. The pH was fixed at 12.0 and the ammonia in the combination maintained at 10000 ppm. Nitrogen continuously purged the tank reactor at 1 L/min. Precursor particles were allowed to nucleate and grow in the solution over run time of 10 hours. The precursor particles were washed, filtered and dried. Table 1 presents certain measured properties of the particles.

TABLE 1

| Property | Unit | Value |
|---|---|---|
| Ni Content | mol % | 88.36 |
| Mn Content | mol % | 9.88 |
| Mg Content | mol % | 1.76 |
| Size-Dₘᵢₙ | mm | 12.00 |
| Size-D10 | μm | 15.98 |
| Size-D50 | μm | 19.97 |
| Size-D90 | μm | 26.03 |
| Size-Dₘₐₓ | μm | 44.00 |
| Tap Density | g/cm³ | 2.05 |
| BET Surface Area | m²/g | 4.11 |

### Example 10

Precursor particles prepared according to Example 9 were calcined in order to form Li_{1.02}Ni_{0.88}Mn_{0.10}Mg_{0.02}O₂. The precursor particles were mixed in an orbital mixer with lithium hydroxide. Following mixing, the mixed powder was transferred to an alumina high-temperature tray and heated in a furnace in flowing oxygen at 500° C. for 10 hours. A ramp rate of the furnace was 2° C. per minute. The heated powder was allowed to cool in the furnace after it is turned off. The sample was subsequently ground by mortar and pestle, sieved, and then re-fired at 775° C. in flowing oxygen gas for 40 hours. The ramp rate was 2° C. per minute. After the second heating was completed, the furnace was turned off and the heated powder allowed to cool (i.e., using a natural cooling rate). This final sintered powder, which was black in appearance, was broken up and ground by mortar and pestle, sieved, and then collected for use in an electrochemical battery cell.

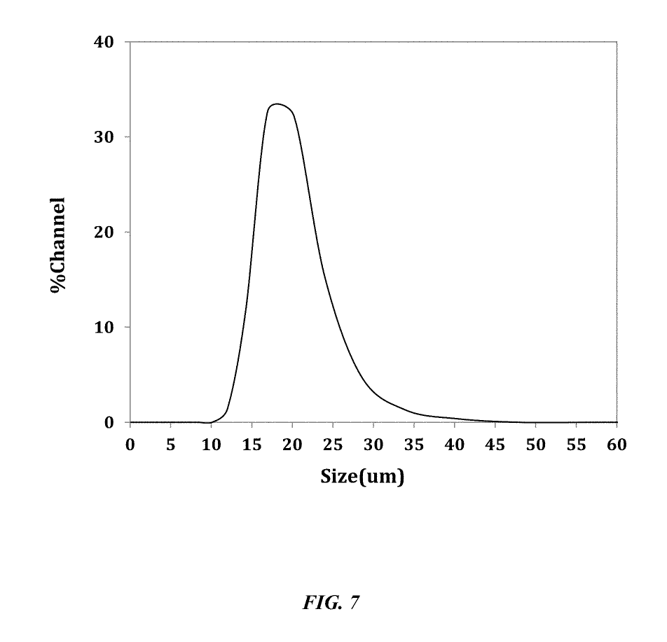

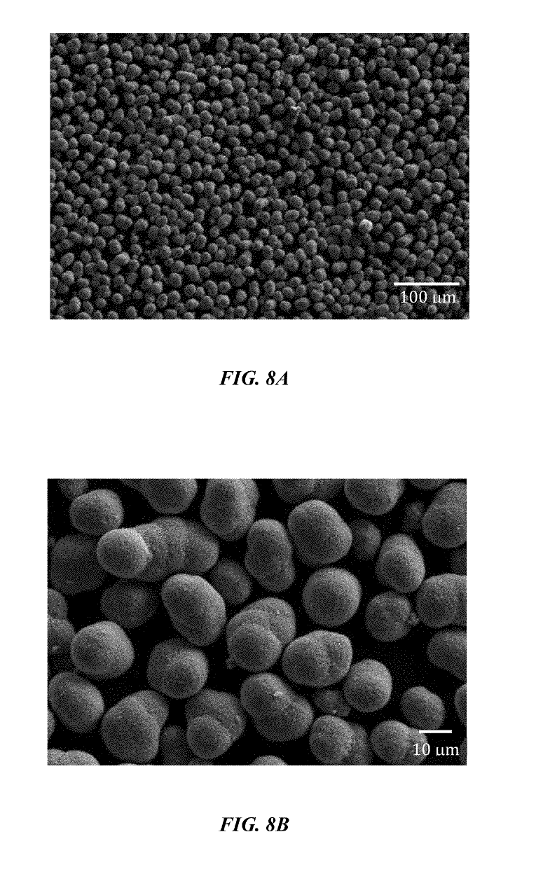

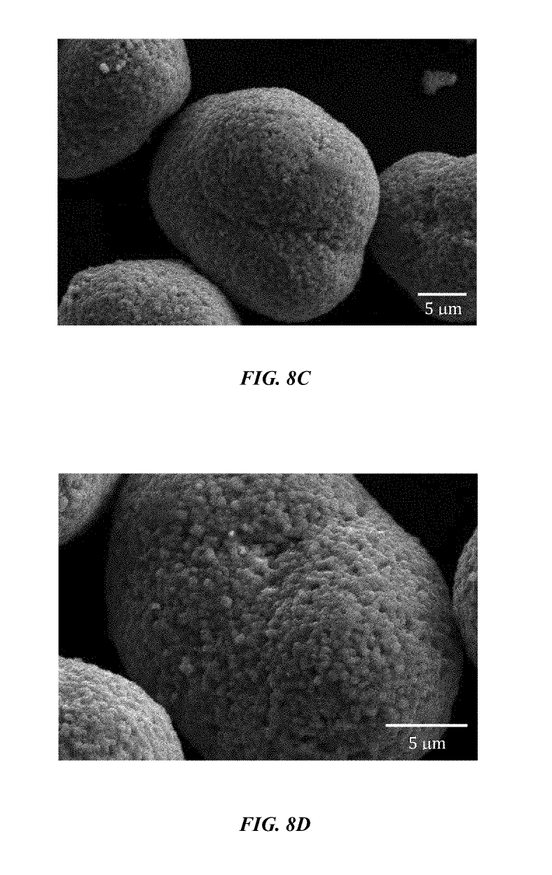

Portions of the collected powder were also set aside for analysis. Powder X-ray diffraction of the Li_{1.02}Ni_{0.88}Mn_{0.10}Mg_{0.02}O₂ cathode active material indicated a tetragonal lattice cell having lattice parameters of a=2.8789 Å and c=14.2210 Å. The D₁₀, D50, and D₉₀ particle sizes were determined to be, respectively, 15.98, 18.87, and 26.04 μm. BET surface area of the powder was measured at 0.11 m²/g. FIG. 7 presents a graph of the particle size distribution of the portion of the collected powder. FIGS. 8A-8D present scanning electron micrographs of the portion of the collected powder at 200, 1000, 3000, and 5000 times magnification, respectively. Pressed pellets of the collected powder (i.e., pressed at 200 MPa) had a density of 3.16 g/cm³.

### Example 11

It will be understood that the cathode active materials presented herein are suitable for use in lithium batteries. For example, and without limitation, the cathode active material of Example 10 (i.e., Li_{1.02}Ni_{0.88}Mn_{0.10}Mg_{0.02}O₂) was further processed into an electrode laminate for a lithium-ion coin cell (i.e., processed as a cathode active material for a lithium battery). The electrode laminate was made by preparing a 90:5:5 weight percent slurry of, respectively, Li_{1.02}Ni_{0.88}Mn_{0.10}Mg_{0.02}O₂, carbon, and a solvent comprising polyvinylidene difluoride (PVDF) binder in n-methyl-pyrrolidinone (NMP). This slurry was cast onto an aluminum current collector sheet using a doctor blade, thereby producing a wet electrode laminate. The wet electrode laminate was dried in air for 4 hours at 75° C. in air, followed by drying under vacuum at 75° C. for 16 hours. The dried electrode laminate was then calendared and circular electrodes punched out (i.e., 9/16-inch diameter). The circular electrodes were incorporated into size 2032 coin cells (Hohsen, Japan). The coin cells included lithium as a counter electrode (i.e., as an anode); an electrolyte mixture comprising 1.2M LiPF₆ salt and a 3:7, by weight, solvent of ethylene carbonate (EC) and ethylmethyl carbonate (EMC), respectively; and a separator formed of Celgard 2325 tri-layer propylene.

The coin cells were placed on a Maccor Series 2000 tester and cycled in galvanostatic mode at room temperature within a voltage window from 4.3 V to 2.75V (inclusive of endpoints). A series of electrochemical, formation, and cycling tests were conducted within the voltage window. For cell formation, a constant current of 0.1C was applied to each coin cell during a charge process. Then, a constant voltage was applied until a charging current was equal to or less than 0.025C. The coin cells were subsequently discharged at a constant current of 0.1C until depleted. In this manner, the coin cells were cycled through charge and discharge processes. For cycle life testing, a total of 50 cycles of charging and discharging were conducted using a constant charge rate of 0.7C, followed by a constant voltage until the charging current was equal to or less than 0.05C. A constant discharge rate of 0.33C was used for discharging.

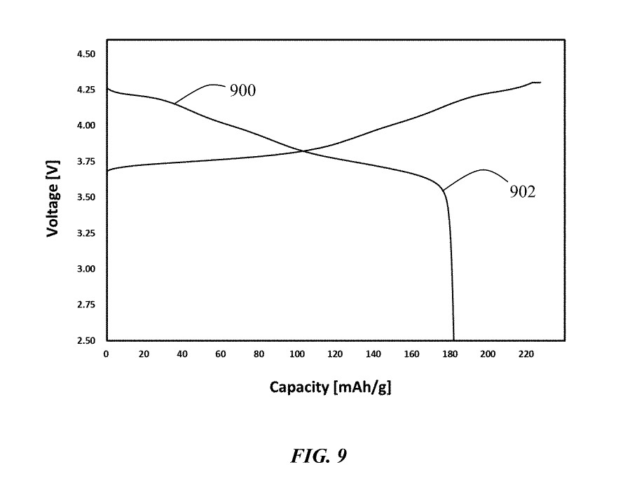

FIG. 9 presents a graph containing a charge profile 900 and a discharge profile 902 of a coin cell incorporating the Li_{1.02}Ni_{0.88}Mn_{0.10}Mg_{0.02}O₂ cathode active material, according to an illustrative embodiment. The charge and discharge profiles 900, 902 correspond to a first cycle. The charge profile 900 terminates at a capacity of 227.29 mAh/g while the discharge profile 902 begins at a capacity of 181.96 mAh/g.

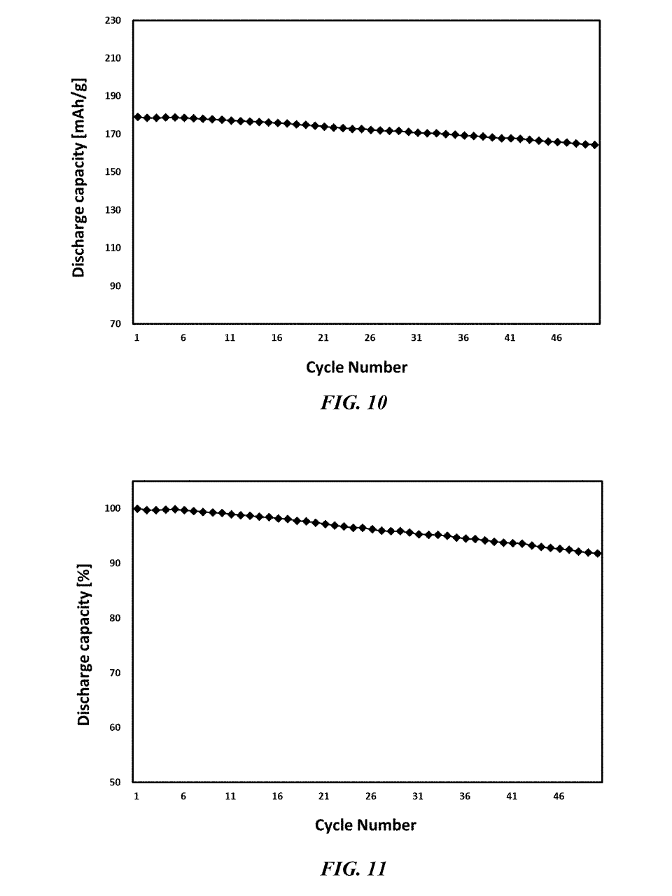

FIG. 10 presents a plot of data representing a discharge capacity of a coin cell incorporating the Li_{1.02}Ni_{0.88}Mn_{0.10}Mg_{0.02}O₂ cathode active material during power cycling. Fifty cycles are presented in FIG. 10. The discharge capacity varies from 179.09 mAh/g (1^{st} cycle) to 167.47 mAhg (50^{th} cycle). FIG. 11 presents a plot of data representing a cycle retention of the coin cell of FIG. 10 during power cycling. The cycle retention corresponds to a percentage calculated by dividing a discharge capacity at each cycle by that of the first cycle, multiplied by 100. The coin cell retained greater than 90% of its charge capacity over fifty cycles.

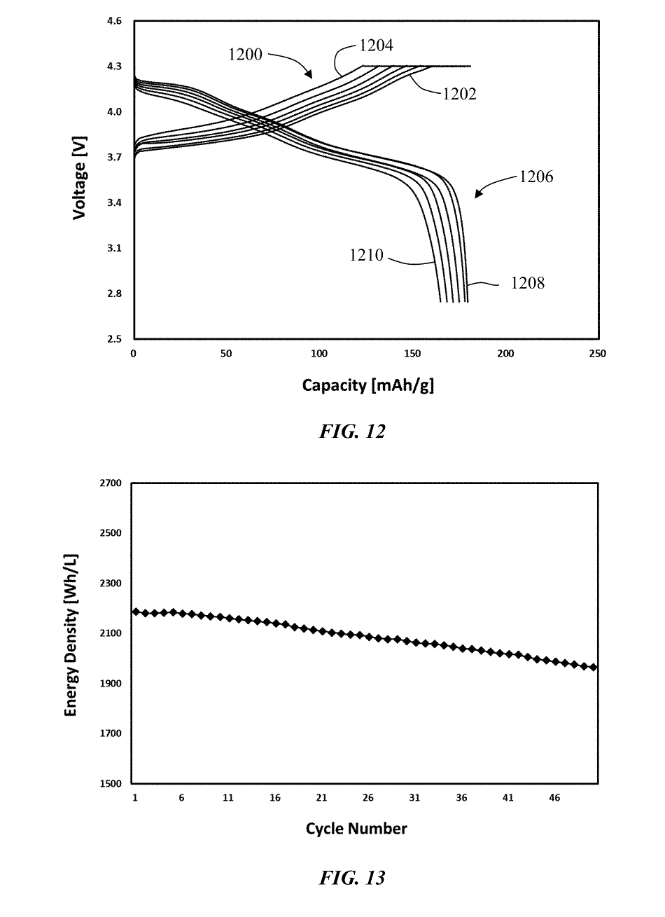

FIG. 12 presents a variation of voltage with capacity of the coin cell of FIG. 10 during power cycling. Fifty cycles are presented in FIG. 12. Each cycle includes a charging profile 1200 and a discharging profile 1206. Every tenth cycle is shown for each profile type (i.e., 1^{st}, 10^{th}, 20^{th}, 30^{th}, 40^{th}, and 50^{th} cycles). Individual charging profiles shift to lower capacities (i.e., to the left in FIG. 11) as cycling progressively increases from a first charging cycle 1202 to a fiftieth charging cycle 1204. Similarly, individual discharging profiles shift to lower capacities as cycling progressively increases from a first discharging cycle 1208 to a fiftieth discharging cycle 1210.

FIG. 13 presents a plot of data representing an energy density of the coin cell of FIG. 10 during power cycling. Fifty cycles are presented in FIG. 13. The energy density varies from 2187.24 Wh/L (1^{st} cycle) to 1965.19 Wh/L (50^{th} cycle). The coin cell retained over 80% of its energy density over fifty cycles.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of the specific embodiments described herein are presented for purposes of illustration and description. They are not targeted to be exhaustive or to limit the embodiments to the precise forms disclosed. It will be apparent to one of ordinary skill in the art that many modifications and variations are possible in view of the above teachings.

What is claimed is:

1. A compound of Formula (I):
LiₓNiₐM_{b}N_{c}O₂ (I)
wherein
M is at least one element selected from Mn, Ti, Zr, Ge, Sn, and Te;
N is at least one element selected from Mg, Be, Ca, Sr, Ba, Fe, Ni, Cu, Zn, and any combination thereof;
0.9<x<1.1;
0.7<a<1;
0<b<0.3;
0<c<0.3; and
a+b+c=1.

2. The compound of claim 1, wherein 0.05<b<0.3 and 0.05<c<0.3.

3. The compound of claim 1, wherein M is Mn and N is Mg.

4. The compound of claim 1, further comprising a coating disposed on a surface thereof and formed of a metal oxide, a metal fluoride, a metal phosphate, or any combination thereof.

5. A compound of Formula (III):
(1−y)LiₓNiₐM_{b}N_{c}O₂.yLi₂MeO₃ (III)
wherein
M is selected from Mn, Ti, Zr, Ge, Sn, Te, and a combination thereof;
N is selected from Mg, Be, Ca, Sr, Ba, Fe, Ni, Cu, Zn, and a combination thereof;
Me is selected from Mn, Ti, Ru, Zr, and a combination thereof;
0≦y≦0.3;
0.9<x<1.1;
0.7<a<1;
0<b<0.3;
0<c<0.3; and
a+b+c=1.

6. The compound of claim 5, wherein, 0.05<b<0.3 and 0.05<c<0.3.

7. The compound of claim 5, wherein M is Mn, N is Mg, and Me is Mn.

8. The compound of claim 5, further comprising a coating disposed on a surface thereof and formed of a metal oxide, a metal fluoride, a metal phosphate, or any combination thereof.

9. A cathode comprising a cathode current collector and a cathode active material comprising the compound according to claim 1.

10. A battery cell comprising:
an anode comprising an anode current collector and an anode active material disposed over the anode current collector; and
a cathode according to claim 9.

11. A portable electronic device comprising:
a set of components powered by a battery pack, the battery pack comprising the battery cell according to claim 10.

12. A compound of Formula (V):
NiₐM_{b}N_{c}Me_{d}(OH)₂ (V)
wherein
M is selected from Mn, Ti, Zr, Ge, Sn, Te, and a combination thereof;
N is selected from Mg, Be, Ca, Sr, Ba, Fe, Ni, Cu, Zn, and a combination thereof;
Me is selected from Mn, Ti, Ru, Zr, and a combination thereof;
0.7<a<1;
0<b<0.3;
0<c<0.3; and
0≦d≦0.3.

13. The compound of claim 12, wherein 0.05<b<0.3

14. The compound of claim 12, wherein 0.05<c<0.3.

15. The compound of claim 12, wherein:
M is Mn; and
N is Mg.

16. The compound of claim 15, wherein 0.05<b<0.3.

17. The compound of claim 15, wherein 0.05<c<0.3.

18. The compound of claim 15, wherein 0.05<b<0.3 and 0.05<c<0.3.

19. The compound of claim 12, wherein Me is Mn.

20. A battery cell comprising:
an anode comprising an anode current collector and an anode active material disposed over the anode current collector; and
comprising a cathode current collector and a cathode active material comprising the compound according to claim 12.
